(19) United States
(12) Patent Application Publication
(10) Pub. No.: US 2015/0253813 A1
(43) Pub. Date: Sep. 10, 2015

(54) SOFT MOUNT FOR TABLET FORMAT ELECTRONIC DEVICES

(71) Applicant: Kyle Nicholas Morrow, Enumclaw, WA (US)

(72) Inventor: Kyle Nicholas Morrow, Enumclaw, WA (US)

(21) Appl. No.: 14/196,161

(22) Filed: Mar. 4, 2014

(51) Int. Cl. G06F 1/16; F16M 13/02

(52) U.S. Cl. CPC G06F 1/1626; G06F 1/1633; F16M 13/022

(57) ABSTRACT

A flexible, stowable, soft mount device suitable for removably mounting tablet format electronics onto seat back headrests, pillows, plush toys, exercise equipment, and other objects without need of specific mounting brackets. The soft mount device provides for hands free use of the mounted tablet including utilizing a touchscreen while providing protection to said removably mounted tablet.

### BACKGROUND OF THE INVENTION

1. Field of the Invention

The present invention generally relates to a tablet format electronic soft mount device suitable for a mounting onto a variety of supports. More particularly, the invention relates to a device that mounts a tablet electronic devise onto the back of a vehicle seat, pillow, plush toy, and the like. Further the invention relates to an easily transportable, foldable, mounting device for use with tablet format electronics.

2. Description of the Related Art

There are a number of electronic device mounts, especially for use in vehicles. These mounts are composed of substantially rigid materials and are not foldable such that they can be easily transported from one location to another. Additionally, they all require a dedicated mounting arrangement limiting the objects that the mount can be attached too. To change mounting locations thus is either not possible or requires additional mounting brackets. Such brackets are specialized to mount on a single type of support such as, for example, the supports of a moveable headrest, handle bars on a bicycle or health equipment support, a cup holder, air vent grill, and the like. For use in mounting in a vehicle there is the further limitation that mounting to a headrest that in integral to the seat such a sports car type bucket seat is not possible. Finally, there is no teaching for providing a protective screen to cover the mounted tablet or for allowing the use of the touch screen through a screen protector.

For example, U.S. Patent Application Publication No. 2013/0181492 published Jul. 18, 2013 to Prescott et al. is indicative of the current state of the art and teaches a substantially rigid tablet computer mount requiring a headrest having metal rods mounting the headrest to the seat back for mounting the computer mount to the seat. Additionally, there is no teaching of a screen protection layer for the tablet and various styles of headrests require different mounting means.

Thus there remains a need for a tablet style electronic device mount that is easily mounted to a variety of supports using a single mounting means, is easily rolled up, or folded for transport. Further, there remains a need to provide a protective screen over the face of a table style electronic device that both protects the screen and allows full use of a touch screen.

### DISCLOSURE OF THE INVENTION

The present invention provides advantages and alternatives over the prior art by providing a soft, flexible, stowable mounting device for tablet style electronic devices that provides for mounting said devices on a plurality of different supports using a single mounting means.

According to a further aspect of the present invention, there is provided soft, flexible, stowable mounting device for tablet style electronic devices that may be easily rolled up or folded allowing easy transportation between mounting locations in a pocket, purse, bag, or the like.

According to yet another aspect of the present invention there is provided said flexible mounting device having a protective screen protector over said electronic devise's screen that allows for viewing the screen and fully utilizing the touch functions of a touch screen device.

According to a yet further aspect of the present invention there is provided a flexible mounting device for tablet style electronic devices that allows for mounting on the headrest of any type vehicle seat, on a pillow, on a plush toy, on exercise equipment and the like by a single mounting means comprising an elastic fabric pouch on the back of said flexible mounting device.

According to still another aspect of the present invention the there is provided a flexible mounting device for tablet style electronic devices suitable for use as entertainment devices for children.

According to still yet another aspect of the present invention there is provided a soft, flexible, stowable, mount for mounting a tablet format electronic devise to a plurality of supports using a pouch mounting system comprising in cooperative combination: a tablet format electronic device mounting pouch 10 comprising; a frame member having a top, a bottom, and first and second sides, power/button cutouts on said first and second sides, a headphone jack access bore, and a tablet mounting pouch opening on side top, a co-operating frame stiffening member, a tablet screen window, and a mounting member comprising a stretchable fabric pouch.

Yet still another aspect of the present invention there is provided a soft, flexible, stowable, mount for mounting a tablet format electronic devise to a plurality of supports using a pouch mounting system comprising in cooperative combination: a tablet format electronic device mounting pouch 10 comprising; a frame member having a top, a bottom, and first and second sides, power/button cutouts on said first and second sides, a headphone jack access bore, and a tablet mounting pouch opening on side top, a tablet screen window, and a mounting member comprising a stretchable fabric pouch.

The present invention thus advantageously provides a soft, flexible, stowable, mounting device for tablet style electronic devices that is flexible, protective, easily mounted and dismounted, and may be mounted on a diverse variety of objects by means of a single elastic pouch mounting system.

### BRIEF DESCRIPTION OF THE DRAWINGS

FIG. 1 shows a plan front view of a preferred embodiment of the claimed invention.

FIG. 1a shows a cross section view through line A-A of FIG. 1.

FIG. 2 shows a perspective back view of the preferred embodiment of the claimed invention of FIG. 1 showing the mounting pocket opening.

FIG. 3 shows a plan top view of the preferred embodiment of the claimed invention of FIG. 1.

FIG. 4 shows a perspective front view of a preferred embodiment of the claimed invention mounted on a pillow.

FIG. 5 shows a perspective front view of a preferred embodiment of the claimed invention mounted on a vehicle seat headrest.

FIG. 6 shows a front view of a sizing pouch being used to mount a tablet having a smaller size than the size of the claimed invention's tablet holding pouch.

### DESCRIPTION OF THE PREFERRED EMBODIMENTS OF THE INVENTION

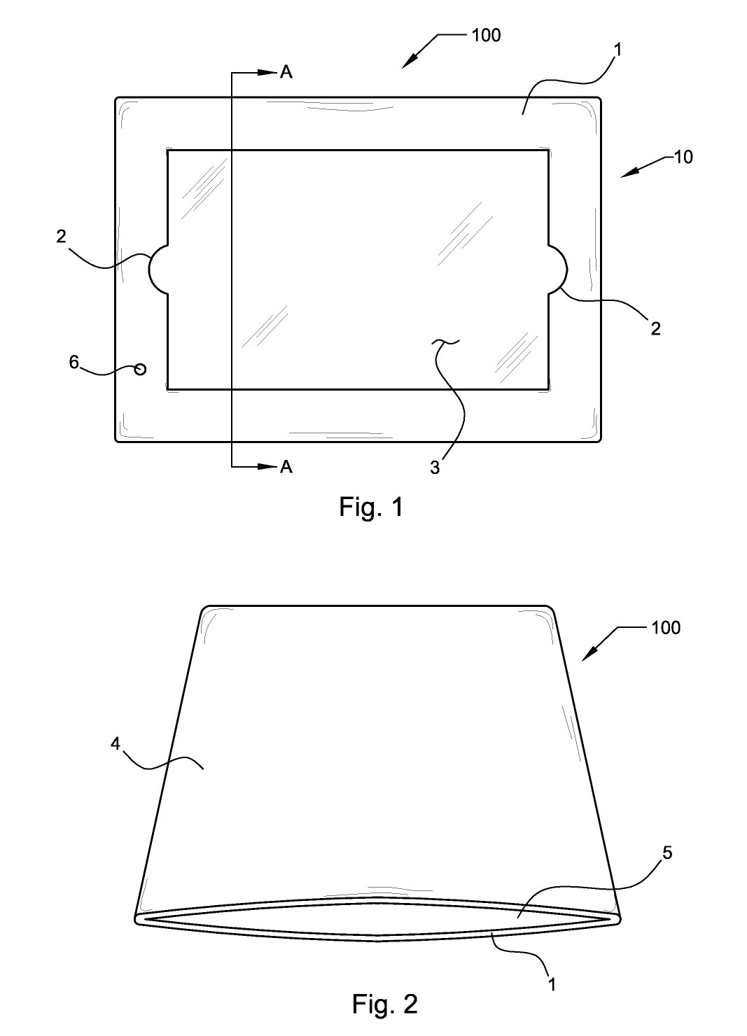

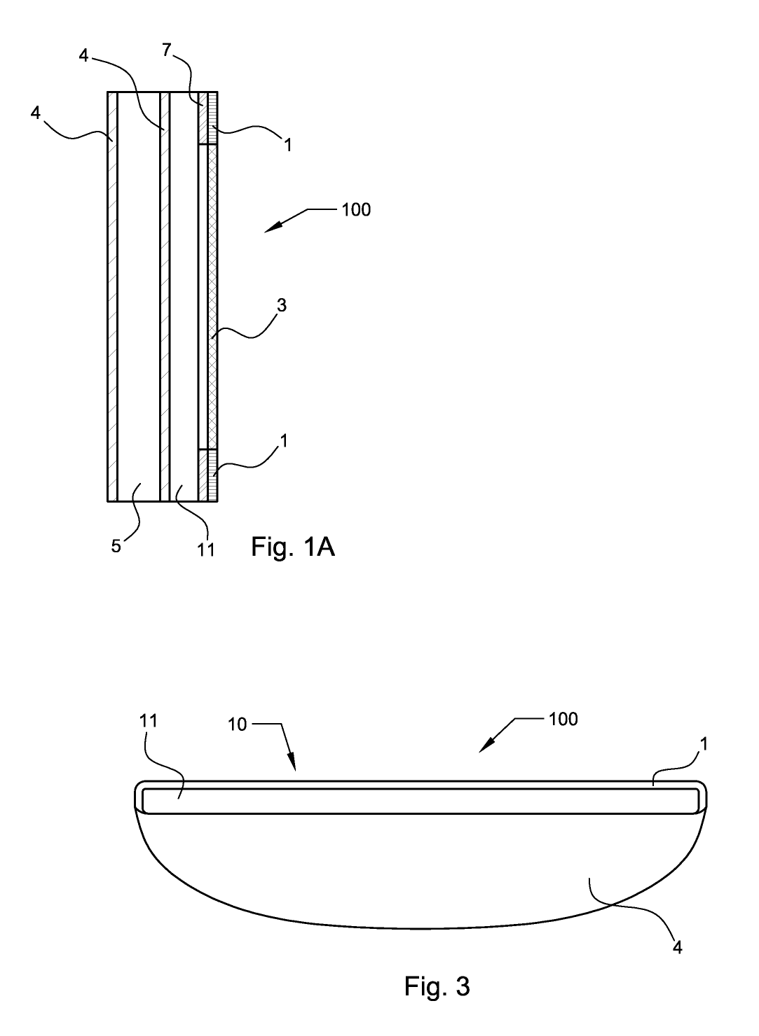

Reference will now be made to the drawings, wherein to the extent possible like reference numerals are utilized to designate like components throughout the various views. Referring to FIG. 1, there is presented a front plan view of the claimed electronic tablet, soft, flexible, stowable, mount 100 comprising tablet holding pouch 10 having a frame member 1 with power/home button cutouts 2, surrounding a tablet screen window 3. Frame member 1 further having a headphone jack access bore 6. Additionally, there is a co-operating frame stiffening member 7 (see FIG. 1A) providing additional form stability to the holding pouch 10 while retaining the ability to fold, roll, or otherwise compact said electronic tablet mount 100 for storage when not in use. Said tablet screen window 3 is substantially transparent and allows for tactile use of a tablet's touchscreen.

FIG. 1a shows a cross section through line A-A of the claimed invention shown in FIG. 1 of said electronic tablet mount 100 showing tablet holding pouch 10 comprising a frame member 1, tablet screen 3, frame stiffening member 7, tablet pouch 11, mounting pouch 5, and mounting pouch 4.

Referring now to FIG. 2, there is shown perspective rear view of the claimed invention 100 viewed from the bottom showing the back mounting pouch 4 having a back mounting opening 5 for mounting said claimed invention 100 to a plurality of different mounting supports. Also shown is the bottom edge of tablet holding pouch 10.

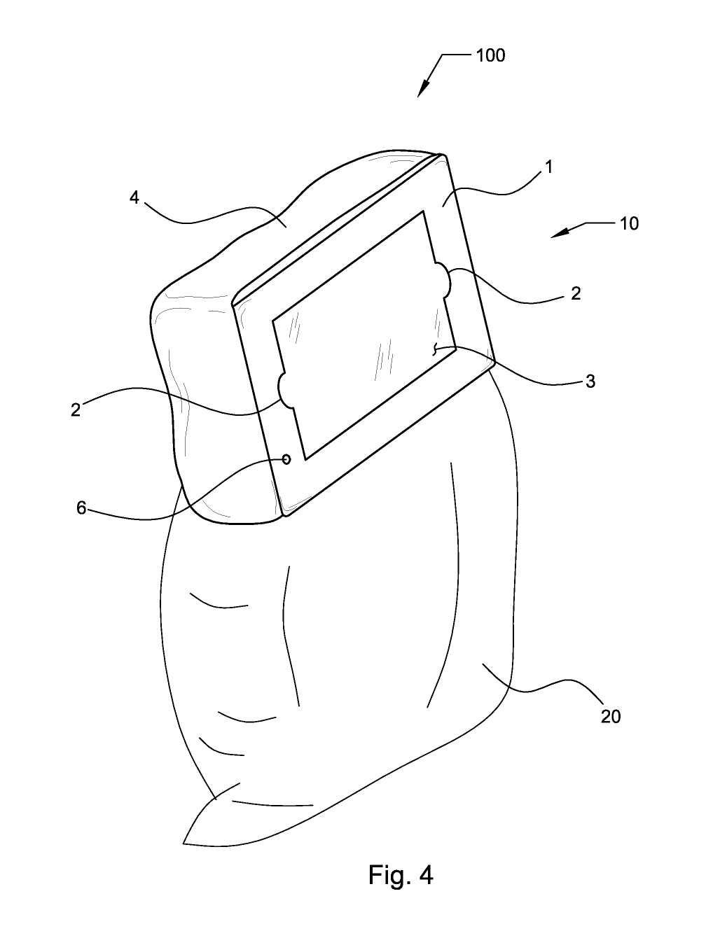

Turning now to FIG. 3, there is shown a top plan view of the claimed invention 100 comprising a tablet holding pouch 10 having a frame member 1, a back mounting member 4, and tablet mounting opening 11 located behind frame member 1 and back mounting member 4.

FIG. 4 shows the claimed invention 100 mounted on a pillow 20 by inserting a portion of said pillow into said back mounting member 4 opening 5 (see FIG. 2). Also shown is tablet holding pouch 10 having a frame member 1 with power/home button cutouts 2, surrounding a tablet screen window 3, and a headphone jack access bore 6.

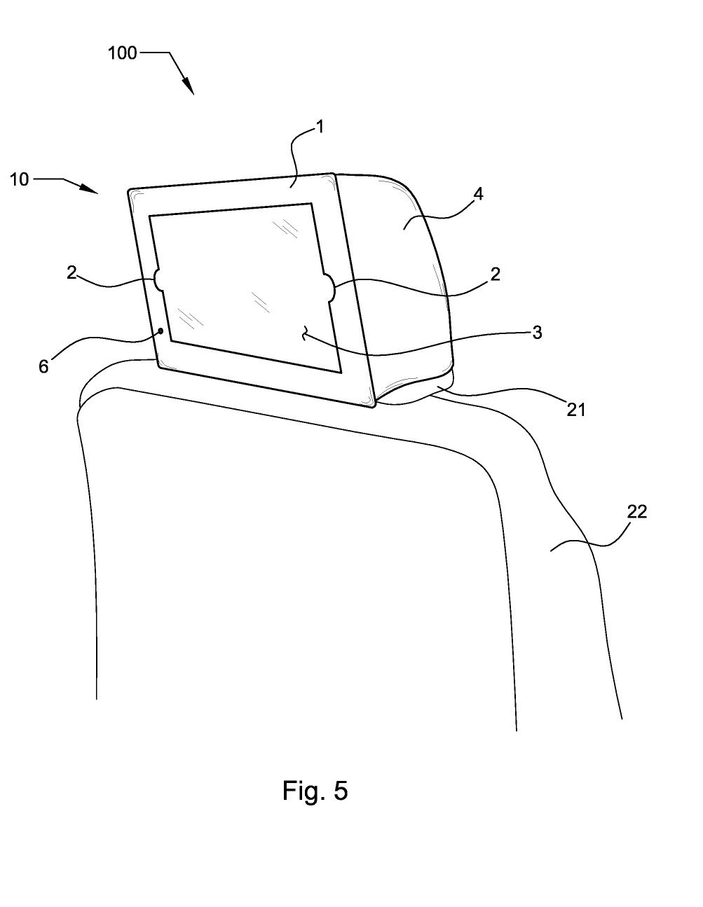

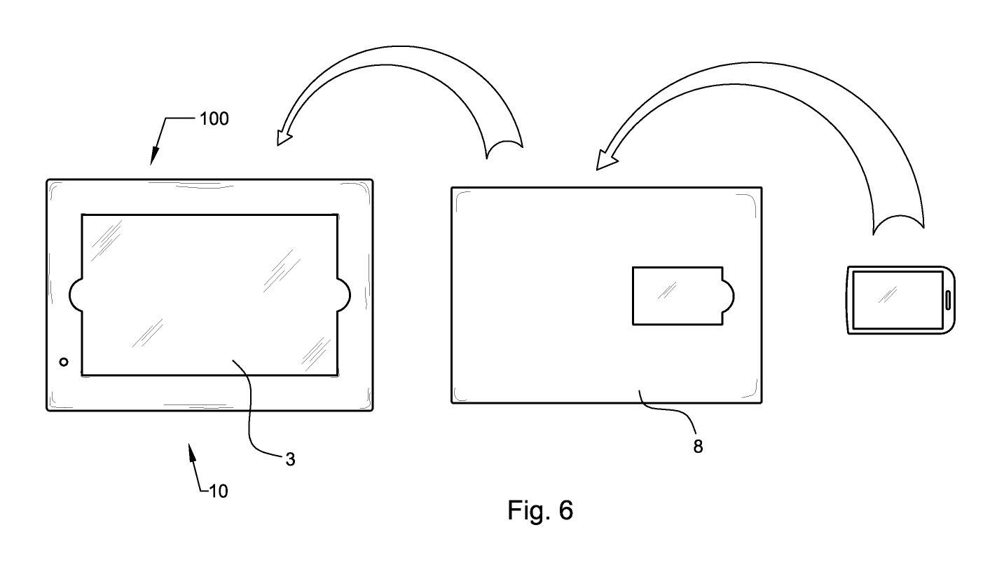

FIG. 5 shows the claimed invention 100 mounted on a vehicle headrest 21, mounted on vehicle seat 22. More particularly shown is back mounting member 4 mounted upon said vehicle headrest 21 by way of back mounting member pouch opening 5. Also shown, are tablet holding pouch 10 having a frame member 1 with power/home button cutouts 2, surrounding a tablet screen window 3, and a headphone jack access bore 6.

Finally, FIG. 6 shows the use of a positioning pouch 8 suitable for mounting a tablet having a smaller dimensions that the tablet holding pouch 10. This said positioning pouch 8, being dimensioned to position the smaller tablet in a desired location within the tablet holding pouch 10 tablet screen window 3, of the claimed electronic tablet, soft, flexible, stowable, mount 100. FIG. 6 shows the mounting of such smaller dimensioned tablet within said positioning pouch 8 and said tablet and positioning pouch 8 being mounted within said tablet holding pouch 10.

The frame member 1 may be comprised of any desired flexible fabric including vinyl, Nylon, Dacron, canvas, Polyurethane (PU) and the like. Currently preferred is polyurethane (PU) fabric. The frame stiffening member 7 may be comprised of any desired flexible material which will help maintain the shape of the tablet mounting pouch 10 while simultaneously allowing for folding, rolling, and the like for storing the claimed invention 100 when not in use, including, but not limited to high density closed cell foam sheet, elastomer sheet, HDPE sheet, and the like in thicknesses from about 0.010 to about 0.10 inches. Currently preferred is HDPE 0.020″ thick. The back mounting member 4 comprises a stretchable fabric including but not limited to, two-way stretch fabric, four-way stretch fabric, Spandex fabrics and Lycra fabrics. Currently preferred is Spandura brand Cordura/Lycra fabric. The tablet screen window 3 preferably comprises a transparent plastic material with the ability to allow touch input to the touch screen of a tablet form electronic device. Currently preferred is clear vinyl. Methods of construction may be any known in the art suitable for the selected materials of construction. These known methods include, but are not limited to, sewing, gluing, welding, and the like. Currently preferred is sewing.

It is to be understood that power/home button cutouts 2 and headphone jack access bore 6 may be positioned to provide access to these tablet features on various brands and style of tablets. It is to be further understood that in an embodiment where the tablet screen window 3 covers the power/home button(s) no cutouts 2 are required as these buttons can be actuated through tablet screen window 3.

Thus the claimed tablet format electronic device mount of the claimed invention provides for mounting on a plurality of different objects without the need for elaborate installation parts or procedures. Instead a pouch made of a stretchable fabric is used as a universal mounting means. Objects that the claimed invention may be easily mounted on, include but are limited to, vehicle headrests that are an integral part of a seat mounding, vehicle headrests that are mounted on a seat back by means of rods, pillows, plush toys, airplane seat backs or trays, monitoring devices mounted on training and exercise equipment, and the like. The claimed invention can be mounted and dismounted in seconds leaving no mounting hardware behind and without the requirement of any tools. The claimed mount invention can be folded, rolled up, or otherwise easily stowed for storage or transport on any means of transportation in pockets, bags, totes, and the like. Once mounted and having a tablet format device installed the tablet format device may be used hands free.

In practice the electronic tablet, soft, flexible, stowable, mount 100 is mounted to a rigid support by first mounting the tablet within tablet holding pouch 10 and then the back mount member 4 is stretched over the rigid support. For use with soft supports such as pillows and plush toys, for example, after mounting the tablet in the electronic tablet, soft, flexible, stowable, mount 100, a portion of the soft support is pushed into the back mount member 4 to complete the mounting onto the soft support.

One particularly preferred embodiment of the present invention provides for a soft, flexible, stowable, mount for mounting a tablet format electronic devise to a plurality of supports using a pouch mounting system comprising in cooperative combination: a tablet format electronic device mounting pouch 10 comprising; a frame member having a top, a bottom, and first and second sides, power/button cutouts on said first and second sides, a headphone jack access bore, and a tablet mounting pouch opening on side top, a co-operating frame stiffening member, a tablet screen window, and a mounting member comprising a stretchable fabric pouch.

Another particularly preferred embodiment of the present invention provides for a soft, flexible, stowable, mount for mounting a tablet format electronic devise to a plurality of supports using a pouch mounting system comprising in cooperative combination: a tablet format electronic device mounting pouch 10 comprising; a frame member having a top, a bottom, and first and second sides, power/button cutouts on said first and second sides, a headphone jack access bore, and a tablet mounting pouch opening on side top, a tablet screen window, and a mounting member comprising a stretchable fabric pouch.

Although the preferred embodiments of the present invention has been disclosed, various changes and modifications may be made without departing from the scope of the invention as set forth in the appended claims.

What is claimed is:

1. A soft, flexible, stowable, mount for mounting a tablet format electronic devise to a plurality of supports using a pouch mounting system comprising in cooperative combination:
a tablet format electronic device mounting pouch 10 comprising;
a) a frame member having a top, a bottom, and first and second sides, power/button cutouts on said first and second sides, a headphone jack access bore, and a tablet mounting pouch opening on side top,
b) a co-operating frame stiffening member,
c) a tablet screen window, and
d) a mounting member comprising a stretchable fabric pouch.

2. A soft, flexible, stowable, mount for mounting a tablet format electronic devise to a plurality of supports using a pouch mounting system as claimed in claim 1 wherein, said frame member comprises vinyl fabric.

3. A soft, flexible, stowable, mount for mounting a tablet format electronic devise to a plurality of supports using a pouch mounting system as claimed in claim 1 wherein, said co-operating frame stiffening member comprises high density closed cell foam.

4. A soft, flexible, stowable, mount for mounting a tablet format electronic devise to a plurality of supports using a pouch mounting system as claimed in claim 1 wherein, said mounting member stretchable fabric is selected from the group comprising two-way and four-way stretchable fabric.

5. A soft, flexible, stowable, mount for mounting a tablet format electronic devise to a plurality of supports using a pouch mounting system as claimed in claim 1 wherein, said mounting member stretchable fabric is selected from the group comprising Spandex and Lycra fabrics.

6. A soft, flexible, stowable, mount for mounting a tablet format electronic devise to a plurality of supports using a pouch mounting system as claimed in claim 1 wherein, said mounting member stretchable fabric comprises Spandura spandex fabric.

7. A soft, flexible, stowable, mount for mounting a tablet format electronic devise to a plurality of supports using a pouch mounting system as claimed in claim 1 wherein, said tablet screen window comprises substantially transparent vinyl.

8. A soft, flexible stowable, mount for mounting a tablet format electronic device to a plurality of supports using a pouch mounting system as claimed in claim 1 wherein, said tablet is positioned in a desired location within the tablet window by means of a positioning pouch.

9. A soft, flexible, stowable, mount for mounting a tablet format electronic devise to a plurality of supports using a pouch mounting system comprising in cooperative combination:
a tablet format electronic device mounting pouch 10 comprising;
a) a frame member having a top, a bottom, and first and second sides, power/button cutouts on said first and second sides, a headphone jack access bore, and a tablet mounting pouch opening on side top,
b) a tablet screen window, and
c) a mounting member comprising a stretchable fabric pouch.

10. A soft, flexible, stowable, mount for mounting a tablet format electronic devise to a plurality of supports using a pouch mounting system as claimed in claim 9 wherein, said frame member comprises vinyl fabric.

11. A soft, flexible, stowable, mount for mounting a tablet format electronic devise to a plurality of supports using a pouch mounting system as claimed in claim 9 wherein, said mounting member stretchable fabric is selected from the group comprising two-way and four-way stretchable fabric.

12. A soft, flexible, stowable, mount for mounting a tablet format electronic devise to a plurality of supports using a pouch mounting system as claimed in claim 9 wherein, said mounting member stretchable fabric is selected from the group comprising Spandex and Lycra fabrics.

13. A soft, flexible, stowable, mount for mounting a tablet format electronic devise to a plurality of supports using a pouch mounting system as claimed in claim 9 wherein, said mounting member stretchable fabric comprises Spandura spandex fabric.

14. A soft, flexible, stowable, mount for mounting a tablet format electronic devise to a plurality of supports using a pouch mounting system as claimed in claim 9 wherein, said tablet screen window comprises substantially transparent vinyl.

15. A soft, flexible stowable, mount for mounting a tablet format electronic device to a plurality of supports using a pouch mounting system as claimed in claim 9 wherein, said tablet is positioned in a desired location within the tablet window by means of a positioning pouch.
